(19) United States
(12) Patent Application Publication
(10) Pub. No.: US 2008/0173576 A1
(43) Pub. Date: Jul. 24, 2008

(54) Method of synthesizing zerovalent iron nanowires and application of the same to groundwater treatment

(76) Inventors: Hee-Chul Choi, Gwangju (KR); Sushil Raj Kanel, Gwangju (KR)

Correspondence Address: HARNESS, DICKEY & PIERCE, P.L.C., P.O. BOX 8910, RESTON, VA, 20195, US

(21) Appl. No.: 11/889,416

(22) Filed: Aug. 13, 2007

(30) Foreign Application Priority Data
Nov. 14, 2006 (KR) 10-2006-0112218

(51) Int. Cl. E02B 15/08; C08K 3/10; B32B 1/00

(52) U.S. Cl. 210/170.07; 524/435; 428/401

(57) ABSTRACT

Provided is a method of easily manufacturing a solution-phase of zerovalent iron nanowires (INW), and more particularly, to a method of synthesizing zerovalent iron nanowires (INW) in which sodium boronhydride is added as a reducing agent to reduce ferrous sulfate mixed with poly(vinyl pyrrolidone).

The present invention provides a simple and efficient method of synthesizing iron nanowires (INW) as one alternative to producing iron nanoparticles (INP). The INW manufactured by this method is very effective in removing groundwater contaminants such as arsenic, chrome (VI) and TCE. The highly reactive INW has great potential for producing an INW-based adsorbent for groundwater remediation.

### CROSS-REFERENCE TO RELATED APPLICATION

This application claims the benefit of Korean Patent Application No. 2006-0112218, filed Nov. 14, 2006, the disclosure of which is hereby incorporated herein by reference in its entirety.

### BACKGROUND OF THE INVENTION

1. Field of the Invention

The present invention relates to a method of easily manufacturing a solution-phase of zerovalent iron nanowires (INW), and more particularly, to a method of synthesizing zerovalent iron nanowires (INW) in which sodium boronhydride is added as a reducing agent to reduce ferrous sulfate mixed with poly(vinyl pyrrolidone).

2. Description of the Related Art

Although contamination of groundwater by toxins such as arsenic (As), chrome (Cr), and trichloroethylene (TCE) is a very serious problem, consumption of groundwater is rapidly increasing all over the world. To remove such contaminants from groundwater, the discovery of a new material has attracted attention. Zerovalent iron (ZVI) is very effective in removing contaminants from groundwater. There is an extensive bibliography on application of nano ZVI to removal of contaminants from groundwater, but no application of an iron nanowire (INW) to environmental remediation has been reported yet. Accordingly, the present inventors first developed INW as an innovative nano material to be used in removing various contaminants from groundwater.

One-dimensional (1D) nano structures (e.g., a wire, a bar and a tube) have been focused on in recent years because of their usefulness in interconnections, nano-sized electronic devices, electronic integrated circuits, automatic sensors, etc. (1). Further, a great deal of effort has been made to achieve bulk synthesis of a semiconductor and a metal nanowire (2, 3). Nano-sized zerovalent iron has high mobility that enables it be used as a colloid and a mobile reactive barrier and makes it highly effective in remediation of groundwater containing arsenic (4). There is an extensive bibliography on application of nanowire, but synthesis and application of Fe⁰ nanowire to groundwater treatment has not been reported yet. Because groundwater is an important source of drinking water, groundwater contamination is a serious environmental problem. Accordingly, there is need for new adsorbents that have dual properties such as contamination deoxidizing ability and adsorbability.

U.S. Pat. No. 7,056,455 discloses a method of synthesizing carbon nanowire, but there is no test of its efficiency in removing contaminants. On the other hand, the present inventors provide a simple and inexpensive method of synthesizing a zerovalent iron nanowire in a laboratory. Further, they confirmed that arsenic, chrome and TCE are removed with high efficiency.

U.S. Pat. No. 7,018,549 discloses an assembly method for multi-nanowires having uniform length from mono-catalyst nano-particles, but the disclosed method only assembles nanowires appropriate for transistors, a display, a sensor, or other such devices. On the other hand, the present inventors provide a simple and inexpensive method of synthesizing zerovalent iron nanowires that react effectively to contaminants in groundwater.

The present inventors first provide a new method of synthesizing iron nanowires (INW). Here, they disclose that INW according to an exemplary embodiment of the present invention can directly remove various contaminants from groundwater. Testing of the present invention showed that contaminants (0.1˜10 mg/L) such as arsenic, chrome (VI) and TCE are removed with only a low concentration (0.1˜1 g/L) of INW. Accordingly, the present invention shows that the INW can be used as an adsorbent for removing arsenic from groundwater and a reducing agent for removing chrome (VI) and TCE.

### SUMMARY OF THE INVENTION

One object of the present invention is to provide nano-sized INW as a new material usable in material and environmental science and engineering, and a method of manufacturing the same.

Another object of the present invention is to apply the INW to removing various contaminants such as arsenic, chrome and TCE through both deoxidizing ability and adsorbability of the INW.

According to one aspect of the present invention, a method of synthesizing zerovalent iron nanowires comprises: a first step of preparing an aqueous FeCl₃.6H₂O solution containing a polymer by dissolving a polymer in water and adding FeCl₃.6H₂O; and a second step of reducing the aqueous FeCl₃.6H₂O solution by adding sodium boronhydride and stirring.

In the inventive synthesis method, the polymer may comprise any water-soluble polymer such as poly vinyl pyrrolidone, polyethyleneglycol, and the like, which guides nanowire to be formed and used as a reaction medium for nanowire synthesis. Preferably, the polymer comprises poly vinyl pyrrolidone (PVP). If there is no polymer, general nanoparticles are formed instead of nanowires.

The PVP may have a concentration of 0.3-1%. If there is less than 0.3% PVP, the nanowire is not formed well, and if there is more than 1% PVP, the PVP may have an effect on the reaction.

Additionally, sonication may be applied to the aqueous FeCl₃.6H₂O solution prepared in the first step. The sonication facilitates dispersion of a reaction material in the aqueous polymer, thereby more efficiently manufacturing the nanowires. Further, the size of the nanowires is adjustable according to the intensity of ultrasonic waves.

The stirring may be magnetic stirring, but is not limited thereto. Alternatively, any type of stirring may be used as long as it mixes the aqueous FeCl₃.6H₂O solution with sodium boronhydride and facilitates reduction.

The sodium boronhydride may have a concentration of 1.5-3M. If the concentration is less than 1.5M, reduction is not performed well, while a concentration of more than 3M is unnecessary.

The aqueous FeCl₃.6H₂O solution may be purged with N₂ gas in the second step. Here, N₂ gas purging means replacing oxygen with N₂ during reduction. Thus, the synthesized nanowire is prevented from oxidation.

According to another aspect of the invention, a zerovalent iron nanowire manufactured according to the present invention has a diameter of 1 to 10 nm and a length of 10 to 1000 nm. The size of the nanowire may be adjustable according to the concentration of the polymer and the intensity of the sonication.

According to still another aspect of the present invention, a composition for removing environmental contaminants comprises the zerovalent iron nanowire.

Here, the environmental contaminants may be groundwater contaminants such as arsenic (As), trichloroethylene (TCE), and chrome (Cr(VI)). The INW according to the present invention has dual properties such as contamination deoxidizing ability and adsorbability.

Although groundwater treatment processes have been developed, there are various problems. The development of a new nanomaterial having dual properties such as both contamination deoxidizing ability and adsorbability is of utmost importance to groundwater remediation. Until now, there has been little research into applying the electro-magnetic, electro-optic, and electro-chemical properties of INW in material science and engineering (5). The present inventor knows that there has been no research into application of INW to groundwater remediation. Accordingly, the present inventor provides new technology for synthesizing INW in a laboratory, which can remove various contaminants such as arsenic, chrome (VI), and TCE. The INW is very efficient in removing such contaminants and is widely applicable to environmental remediation.

The present inventor has investigated the one-dimensional structure of newly synthesized nanowires, and their physical and chemical characteristics with regard to water treatment, through various techniques such as Mossbauer spectra, high resolution HR-TEM, and atomic absorption spectrophotometer (AAS). Further, the present inventor is the first to disclose use of INW in groundwater treatment for removing various contaminants such as arsenic (As), chrome (Cr), trichloroethylene (TCE) and other toxins from groundwater.

### BRIEF DESCRIPTION OF THE DRAWINGS

The above and other objects, features and advantages of the present invention will become more apparent by describing exemplary embodiments of the invention with reference to the attached drawings, in which:

FIG. 1 is a graph showing UV-vis spectra of PVP-NZVI (black), commercial NZVI (red), and PVP (blue), according to an exemplary embodiment of the present invention;

FIG. 2 shows an HR-TEM image of INW synthesized according to an exemplary embodiment of the present invention;

FIG. 3 is a graph showing X-RD images of a PVP-NZVI nanowire (a), NZVI (b), and PVP (c), according to an exemplary embodiment of the present invention;

FIG. 4 is a graph showing a Mossbauer spectrum of a nanowire prepared in a PVP polymer according to an exemplary embodiment of the present invention;

FIG. 5A is a graph showing adsorbability of arsenic (III) to INW as a function of pH (envelope plot);

FIG. 5B is a graph showing adsorbability of Cr (VI) by INW as a function of time (kinetic plot); and

FIG. 5C is a graph showing adsorbability of TCE by INW as a function of time (kinetic plot).

### DETAILED DESCRIPTION OF THE INVENTION

Exemplary embodiments of the present invention will be described below in more detail with reference to the accompanying drawings. The present invention may, however, be embodied in different forms and should not be construed as limited to the embodiments set forth herein.

### First Exemplary Embodiment

### Synthesis of Zerovalent Iron Nanowires (INW)

Poly vinyl pyrrolidone (PVP, 6.5 g) was dissolved in deionized water (1 L), and FeCl₃.6H₂O (iron salt) was added. This solution was treated by sonication, thereby preparing 1M aqueous FeCl₃.6H₂O solution containing 0.5% PVP. The 1M aqueous FeCl₃.6H₂O solution was continuously purged with N₂ gas, and NaBH₄ (50 ml at 2.1M) was additionally dropped thereinto through a separatory funnel at room temperature (about 23° C.) while magnetically stirring. Thus, the aqueous FeCl₃.6H₂O solution was reduced, thereby synthesizing INW material (PVP-NZVI).

### Second Exemplary Embodiment

### UV-Vis Spectrum of INW

PVP-NZVI, PVP and commercial Toda NZVI (1 g/L), which were manufactured in the first exemplary embodiment, were dispersed in deionized water and their UV-vis spectrums were measured by a UV spectrometer (HP 8453 UV-visible spectrophotometer) at a wavelength of 200-750 nm. FIG. 1 shows UV-vis spectrums of a surfactant, PVP, PVP-NZVI and Toda-NZVI products, in which blue, black and red indicate the UV-vis spectrums of PVP, PVP-NZVI and commercial NZVI, respectively. With the surfactant, mild sonication causes PVP-NZVI to have enough absorbance and then finally show mono dispersion in water. The surfactant showed no absorbance peak within the range of 200 to 800 nm, but showed peaks at 246, 308 and 361 nm after combining with Fe⁰. Peaks were shown at 240, 306 and 361 nm in the case of pure NZVI provided by Toda Company. These results apparently show that the present inventor succeeded in making NZVI stable and soluble in the PVP polymer aqueous solution.

### Third Exemplary Embodiment

### Structural Appearance of INW

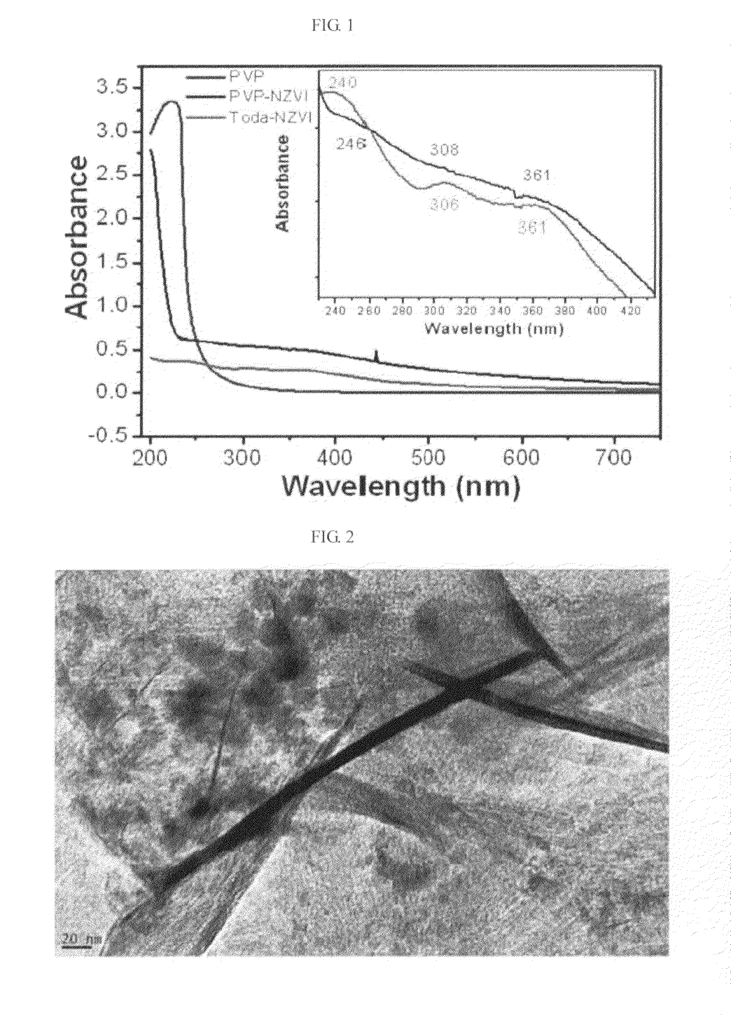

The structural appearance of the INW manufactured in the first embodiment was observed using a high-resolution transmission electron microscope (HR-TEM). The HR-TEM includes a Philips CM300 that operates at an accelerating voltage of 300 KeV. The sample was made by dropping the aqueous INW solution on a copper grid coated with carbon and drying it in a vacuum oven at a temperature of 60° C. FIG. 2 shows an HR-TEM image of INW synthesized in the laboratory. 90% or more of the synthesized INW had a diameter within the range of 1 to 10 nm. Further, the INW was mono-dispersed in the polymer, and had a length of 10 to 1000 nm (see FIG. 2). In FIG. 2, the black line denotes the INW and the surrounding medium denotes the PVP.

### Fourth Exemplary Embodiment

### Checking a Zerovalent State of the INW

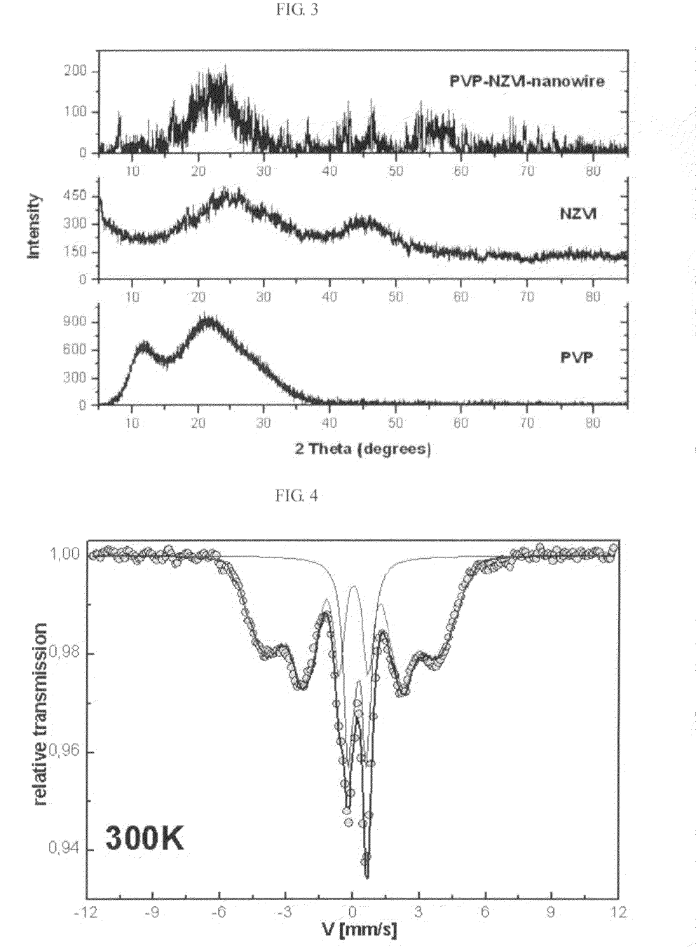

To check the zerovalent state of the INW manufactured in the first exemplary embodiment, X-ray diffraction (XRD) properties of the PVP, the NZVI and INW were researched (refer to FIG. 3). The INW materials were characterized by power X-ray diffraction (XRD) through a Rigaku diffractrometer and monochromatized CuK α radiation (an electric generator at voltage=40 kV and current=40 mA). Diffractograms were recorded in 0.02° steps from 5 through 85° (2 theta) with a counting time of 5 s per step. FIG. 3 shows an XRD image of the nanowire manufactured from the PVP polymer. The PVP in the range of about 10 through 40° (2theta) was amorphous. The NZVI had Fe⁰ coated with iron oxide having a peak in the range of 15 to 30° (2theta).

### Fifth Exemplary Embodiment

### XPS and Mossbauer Spectra of the INW

To check the zerovalent state of the INW manufactured in the first exemplary embodiment, X-ray photoelectron spectroscopy (XPS) and Mossbauer spectra were used. A solid state sample was used in the XPS. The spectrum was obtained using a physical electronics 5500/5600 electron spectroscopy for chemical analysis (ESCA) system. This system employs monochromatic Alk α radiation (1486.7 eV) having an acceptance angle of 7° and a takeoff angle of 65° as an X-ray source. An analysis area for the sample has a diameter of 800 μm and an analysis depth of 8-10 nm. Chemical states of elements were determined from non-linear minimum-square fitting using Physical Electronics' Multipack software, and the results showed approximate estimates of species existing based on reference data (combination energy). The Mossbauer spectra was obtained at 4.2, 77 and 300K using a spectrometer having a triangular waveform and a ⁵⁷Co (50 mCi) source. Hyperfine parameters such as isomer shift (IS); quadrupolar splitting (QS); full width at half maximum (FWHM); % (composition); standard deviation of ±0.02 mms⁻¹ and ±3% were refined using minimum-square fitting of the MOSFIT program. As a function of temperature and applied magnetic field, in situ magnetizations were obtained using a Faraday balance and a Foner apparatus. For research on dehydration, an MIL-82 sample was put into a cryofurnace and gradually heated from 25 to 85° C. At the higher temperature, the sample was left alone for several hours and then cooled to a temperature of 77K in order to obtain the Mossbauer spectrum of a dehydrated state. The size of a crystal domain forming the INW is very small and there is no long distance order. Consequently, XRD or another such method is not well suited to measure properties of the INW. Accordingly, the properties of the INW observed at a temperature of 100° C. were measured using Mossbauer spectrometry. FIG. 4 shows a Mossbauer spectrum of the nanowires prepared in the PVP polymer. The present inventor confirmed that the INW contained 76% Fe⁰ and 24% iron oxide on the basis of the Mossbauer spectrum.

### Sixth Exemplary Embodiment

### Adsorbability of Arsenic (III) to the INW

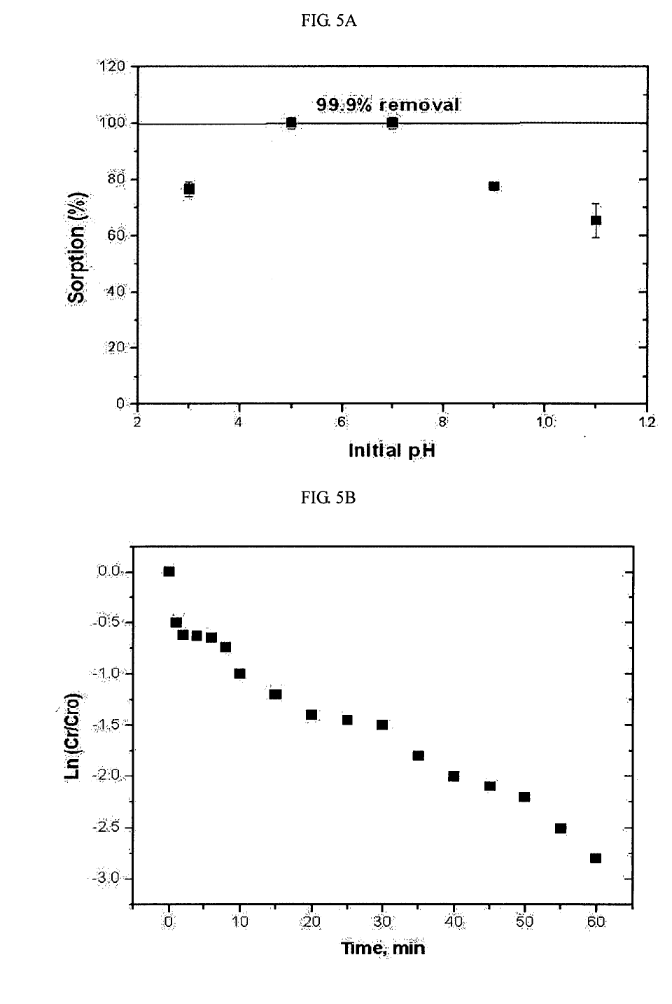

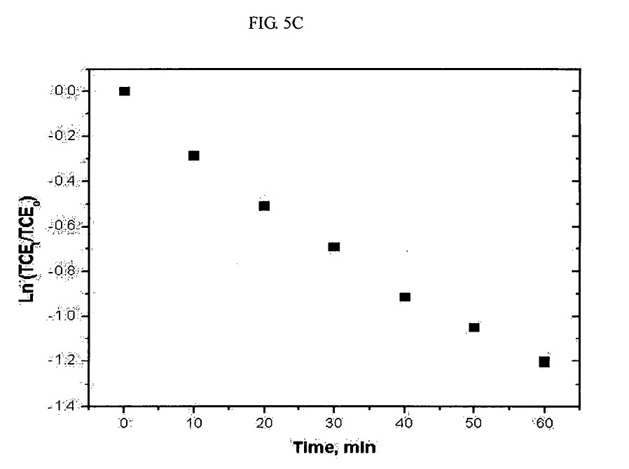

A specific surface area (S_{BET}) of the INW manufactured in the first exemplary embodiment was measured by BET surface area analyzer (ASAP 2020, Micrometritics). All arsenic (As) was analyzed by Hydride Generation Atomic Absorption Spectrophotometry (HGAAS; Perkin-Elmer 5100 PC) having a detection limit of 1 μgL⁻¹As. Reaction conditions were ImgL⁻¹ As(III) NZVI adsorbed to 0.01 gL⁻¹ INW in 0.01M NaCl, and reaction time was 12 hours in pH 7. An effect of pH in adsorption of arsenic (III) to the INW is shown in FIG. 5A. FIG. 5A is a graph showing adsorbability of arsenic (III) to INW as a function of pH (envelope plot). If pH is 3 through 7, removal capability ranges from 68 to 99.9%. However, the removal capability rapidly decreases if pH is lower than 7 or higher than 11. Such pH-dependence can be explained by ionization of both the material for adsorption and the adsorbent, which causes repulsion on the surface and decreases net arsenic (III) adsorption. If pH is lower than 9.2, H₃AsO₃ may become the predominant species or a major species adsorbed. On the other hand, if pH is equal to or higher than 9.2, H₃AsO₃ becomes arsenic (III) predominant species and the NZVI corrosive product surface becomes negative predominant (Fe(III)-0⁻), which induces electrostatic repulsion. Similarly, the present inventor found that the INW (0.1 through 1 g/L) was effective in removing highly concentrated chrome (VI) and TCE (0.1 through 10 mg/L) at a neutral pH.

### Seventh Exemplary Embodiment

### INW Test for Removing Cr and TCE

Likewise, 0.25 mM Cr(VI) was reacted with the INW (0.1 g/L). After the reaction, Cr(VI) aliquots were analyzed by flame MS (Perkin-Elmer 5100 PC). In result, 100% Cr(VI) was removed by the INW of a low concentration. FIG. 5B is a graph showing adsorbability of Cr (VI) by INW as a function of time (kinetic plot). Under reaction conditions of pH7 and 0.01M NaCl, 0.25 mM Cr(VI) was adsorbed to 0.01 gL⁻¹ INW.

Further, it was discovered that the INW according to the present invention is very useful for removing TCE. A batch test was performed to check reactivity between TCE and the INW in solution form. Samples were scarified using a 10 ml glass bottle and a 10 ml serum bottle, respectively, capped with a Teflon line. For the dissolved TCE and the analysis test, TCE and the INW initially had concentrations of 20 mg/L and 1 g/L, respectively. A control group was set up by performing the test without the INW under the same conditions. The samples were introduced from an anaerobic chamber to the bottles and reacted at 200 rpm. Initial pH was 7 and it was not controlled. Sampling times were 0, 10, 20, 40 and 60 minutes. For the concentration analysis of chloride, supernatant was filtered through a 0.2 μm syringe filter and analyzed using ion chromatography (ICS-200, DIONEX). The concentration of TCE was analyzed by applying gas chromatography (HP5890) to TCE having pentane extracted from the supernatant. In result, it was confirmed that the INW of a low concentration (Ig/L) is capable of removing high-concentration TCE (see FIG. 5C). FIG. 5C is a graph showing adsorbability of TCE by INW as a function of time (kinetic plot). Under reaction conditions of pH 7 and 0.01M NaCl, 20 mgL⁻¹ TCE was adsorbed to 1 gL⁻¹ INW.

As described above, the present invention provides a simple method of obtaining individual iron nanowires (INW). This method is one of the best alternatives to producing iron nanoparticles (INP). The INW manufactured by this method is very simple and effective in removing groundwater contaminants such as arsenic, chrome (VI) and TCE. The present inventor showed that the INW can be easily synthesized by reducing ferrous sulfate mixed with a polymer. Because the highly reactive INW is easily manufactured, the present method of manufacturing INW has great potential to produce an INW-based adsorbent for groundwater remediation. In other words, the INW is simply and efficiently synthesized in a laboratory, so that its applicability is high in various fields. According to the present invention, the INW is applicable not only to removing arsenic, chrome (VI), TCE and the like from groundwater, but to various other fields as well.

Although the present invention has been described with reference to certain exemplary embodiments thereof, it will be understood by those skilled in the art that a variety of changes may be made to exemplary embodiments without departing from the spirit and scope of the present invention defined by the appended claims and their equivalents.

What is claimed is:

1. A method of synthesizing zerovalent iron nanowires, comprising:
a first step of preparing an aqueous FeCl₃.6H₂O solution containing a polymer by dissolving a polymer in water and adding FeCl₃.6H₂O; and
a second step of reducing the aqueous FeCl₃.6H₂O solution by adding sodium boronhydride and stirring.

2. The method according to claim 1, wherein the polymer comprises poly vinyl pyrrolidone (PVP).

3. The method according to claim 2, wherein the PVP has a concentration of 0.3-1%.

4. The method according to claim 1, further comprising:
applying sonication to the aqueous FeCl₃.6H₂O solution prepared in the first step.

5. The method according to claim 1, wherein the sodium boronhydride has a concentration of 1.5-3M.

6. The method according to claim 1, wherein the aqueous FeCl₃.6H₂O solution is purged with N₂ gas in the second step.

7. A zerovalent iron nanowire manufactured according to claim 1 and having a diameter of 1 to 10 nm and a length of 10 to 1000 nm.

8. A composition for removing environmental contaminants, comprising the zerovalent iron nanowire according to claim 7.

9. The composition according to claim 8, wherein the environmental contaminants comprise groundwater contaminants such as arsenic (As), trichloroethylene (TCE), and chrome (Cr(VI)).

10. A zerovalent iron nanowire manufactured according to claim 2 and having a diameter of 1 to 10 nm and a length of 10 to 1000 nm.

11. A zerovalent iron nanowire manufactured according to claim 3 and having a diameter of 1 to 10 nm and a length of 10 to 1000 nm.

12. A zerovalent iron nanowire manufactured according to claim 4 and having a diameter of 1 to 10 nm and a length of 10 to 1000 nm.

13. A zerovalent iron nanowire manufactured according to claim 5 and having a diameter of 1 to 10 nm and a length of 10 to 1000 nm.

14. A zerovalent iron nanowire manufactured according to claims 6 and having a diameter of 1 to 10 nm and a length of 10 to 1000 nm.
